(19) United States
(12) Patent Application Publication
(10) Pub. No.: US 2019/0087757 A1
(43) Pub. Date: Mar. 21, 2019

(54) GIS Based Centralized Carbon Footprint Monitoring System and Method Thereof

(71) Applicant: Centre for Development of Telematics, New Delhi (IN)

(72) Inventors: Vipin Tyagi, New Delhi (IN); Pankaj Kumar Dalela, New Delhi (IN); Arpit Singh, New Delhi (IN); Sabyasachi Majumdar, New Delhi (IN); Saurabh Basu, New Delphi (IN); Nidhi Nagpal, New Delhi (IN)

(21) Appl. No.: 16/083,803

(22) PCT Filed: Oct. 5, 2016
(86) PCT No.: PCT/IB2016/055950

§ 371 Date: Sep. 10, 2018

(30) Foreign Application Priority Data
Mar. 12, 2016 (IN) 201611008699

(51) Int. Cl. G06Q 10/06; G06Q 50/06; H02J 3/38

(52) U.S. Cl. CPC G06Q 10/067; H02J 3/381; G06Q 50/06

(57) ABSTRACT

The present disclosure provides a geographic information system (GIS) based centralized carbon footprint monitoring system (CFMS) that can monitor carbon footprint related to geographically distribute power consuming sites that meet their power requirement from multiplicity of power sources. The disclosure provides for real time monitoring of source of electric power among to a particular power consuming site. The captured power source status is periodically communicated to a Centralized Processing System configured to store the data and generate statistical reports relating to carbon footprint of these sites. The statistical reports are prepared by a web application built on top of the Centralized Processing System. Further, to provide a better comprehensibility of the information, the carbon footprint of the power consuming sites for a given period for a desired geographical region is displayed by means of Thematic Maps that are based on Geographic Information System (GIS) of Survey of India.

### TECHNICAL FIELD

The present disclosure relates to the field of carbon footprint monitoring. In particular it pertains to a geographic information system (GIS) based centralized carbon footprint monitoring system (CFMS) that can monitor carbon footprint related geographically distributed power consuming sites such as BTS towers.

### BACKGROUND

Background description includes information that may be useful in understanding the present invention. It is not an admission that any of the information provided herein is prior art or relevant to the presently claimed invention, or that any publication specifically or implicitly referenced is prior art.

Natural sources such as decomposition, volcanic eruptions, ocean release and respiration, etc., had been the only source of CO₂ emission till the time industrial revolution began in early 19th century. Since the advent of industrial revolution, consumption of energy by humankind has grown exponentially. A major part of the energy requirement of the world is today met by fossil fuels that on burning emit gases such as CO₂ that cause greenhouse effect leading to global warming with disastrous results for environment and earth as a whole.

Many measures have been taken in recent years to reduce greenhouse gas emissions. While most of these measures are directed to energy efficient equipment/technologies and development of non-fossil/renewable energy sources that do not emit greenhouse gases, measures are also being taken to check and monitor levels of emissions so that preventive and punitive actions could be taken against defaulters.

In regard to efficient equipment/technologies and methods that result in less greenhouse gas emissions and use of energy sources that are less dependent on fossil fuels, calculation of carbon footprint has been introduced and is defined as total amount of greenhouse gases produced to directly and indirectly support a given activity. Thus carbon footprint of a geographical area such as a city or a nation for a certain period can be carbon footprint of all activities undertaken there during the period. Likewise carbon footprint of a product can be carbon footprint of all activities undertaken to make the product.

Once the size of carbon footprint of an activity or a geographical area is known, a strategy can be devised to reduce it, for example by technological developments, better process and product management, changed Green Public or Private Procurement, carbon capture, consumption strategies, carbon offsetting and others.

Accurate calculation of carbon footprint is difficult because of the large amount of data required. Usually most of data required for calculations is based on assessment and therefore final results could be way off mark.

In developing countries like India uncertain availability of grid power forcing a large number of users to use Diesel Generating sets can leave a considerable carbon footprint. In applications that require uninterrupted power supply such as Base Trans-receiver Stations (BTS) of communication network, dependence on DG power can increase on account of grid power outages resulting in a marked carbon footprint. As these stations especially those of mobile communication network, are geographically distributed, collection of real time data is difficult and time consuming.

There is, therefore, a requirement for more accurate real time, ground level data collection based method for calculating carbon footprint for distributed power generators and additionally displaying the calculated carbon footprint in a meaningful manner.

All publications herein are incorporated by reference to the same extent as if each individual publication or patent application were specifically and individually indicated to be incorporated by reference. Where a definition or use of a term in an incorporated reference is inconsistent or contrary to the definition of that term provided herein, the definition of that term provided herein applies and the definition of that term in the reference does not apply.

In some embodiments, the numbers expressing quantities of ingredients, properties such as concentration, reaction conditions, and so forth, used to describe and claim certain embodiments of the invention are to be understood as being modified in some instances by the term “about.” Accordingly, in some embodiments, the numerical parameters set forth in the written description and attached claims are approximations that can vary depending upon the desired properties sought to be obtained by a particular embodiment. In some embodiments, the numerical parameters should be construed in light of the number of reported significant digits and by applying ordinary rounding techniques. Notwithstanding that the numerical ranges and parameters setting forth the broad scope of some embodiments of the invention are approximations, the numerical values set forth in the specific examples are reported as precisely as practicable. The numerical values presented in some embodiments of the invention may contain certain errors necessarily resulting from the standard deviation found in their respective testing measurements.

As used in the description herein and throughout the claims that follow, the meaning of “a,” “an,” and “the” includes plural reference unless the context clearly dictates otherwise. Also, as used in the description herein, the meaning of “in” includes “in” and “on” unless the context clearly dictates otherwise.

The recitation of ranges of values herein is merely intended to serve as a shorthand method of referring individually to each separate value falling within the range. Unless otherwise indicated herein, each individual value is incorporated into the specification as if it were individually recited herein. All methods described herein can be performed in any suitable order unless otherwise indicated herein or otherwise clearly contradicted by context. The use of any and all examples, or exemplary language (e.g. “such as”) provided with respect to certain embodiments herein is intended merely to better illuminate the invention and does not pose a limitation on the scope of the invention otherwise claimed. No language in the specification should be construed as indicating any non-claimed element essential to the practice of the invention.

### OBJECTIVE OF INVENTION

An object of the present disclosure is to provide a system for carbon footprint monitoring for distributed power consuming sites that draw power from multiple sources.

An object of the present disclosure is to provide a system that can accurately determine the carbon footprint based on real time ground level data collection.

An object of the present disclosure is to provide a system for determining carbon footprint of the distributed power generating sites located in different geographic regions.

An object of the present disclosure is to provide a centralized system for data collection from the distributed power generating sites through secured communication network.

An object of the present disclosure is to provide system and method to effectively display or represent the carbon footprint.

### SUMMARY

Embodiments of the present disclosure relate to carbon footprint monitoring. In particular it pertains to a geographic information system (GIS) based centralized carbon footprint monitoring system (CFMS) that can monitor carbon footprint related to geographically distribute power consuming sites that meet their power requirement in an uninterrupted manner from multiplicity of power sources. Such geographically distributed power consuming sites could be for example but not limited to Base Trans-receiver Stations pertaining to communication networks.

In an embodiment, the present disclosure provides a method for carbon footprint monitoring based on real time monitoring of source of electric power among various power sources such as but not limited to grid or Diesel Generator or battery, to a particular power consuming site. The disclosed method further provides for periodic communication of the captured data from the geographically distributed power consuming sites to a Centralized Processing System that is configured to store the data and generate statistical reports relating to carbon footprint of the geographically distributed power consuming sites.

In an embodiment, the disclosed method further provides for preparation of various statistical reports pertaining to the geographically distributed power consuming sites wherein the statistical reports are prepared by a web application built on top of the Centralized Processing System. The reports can pertain to power status, power outage, and carbon footprint of the power consuming site amongst others.

In an embodiment, to provide a better comprehensibility of the information, the disclosed method provides for geographical region wise display of the carbon footprint of the geographically distributed power consuming sites for a given period by means of a Thematic Map. The thematic map can be based on Geographic Information System (GIS) of Survey of India.

In an embodiment, device/apparatus for monitoring Carbon Footprint of a set of geographically distributed power consuming sites that meet their power requirement in an uninterrupted manner from multiplicity of power sources can comprise of two functional segments: CFMS Field Device and Centralized Processing Device (CPD). The CFMS Field Devices can be located at each of the geographically distributed power consuming sites and can consist of a microcontroller configured to sense status of power sources such as Grid, DG and Battery. In power consuming sites configured for uninterrupted power supply through batteries, it can additionally sense the Battery voltage. In an aspect, sensing the battery voltage can enable to determine operational status of the power consuming site.

In an embodiment, the micro controller of the field device can be further configured to continuously sense the required data and transfer the same to the CPD with the inbuilt GSM/GPRS module after a specific time interval or instantly whenever it detects a change of power status.

In an embodiment, the Centralized Processing Device (CPD) can be a centralized server configured to receive and store the data from plurality of CFMS Field Devices located at geographically distributed power consuming sites and can incorporate a web based solution (CFMS solution) to process the stored data and provide live statistical reports pertaining to power status, power outage, and carbon footprint of the power consuming sites pertaining to the geographically distributed power consuming sites. The Centralized Processing Device (CPD), to provide a better comprehensibility, can further incorporate means of providing geographical region wise information pertaining to the carbon footprint of the geographically distributed power consuming sites for a given period on a Thematic Map. The thematic map can be based on Geographic Information System (GIS) of Survey of India.

In an embodiment, the present disclosure provides a system for monitoring Carbon Footprint pertaining to a set of geographically distributed power consuming sites that meet their power requirement in an uninterrupted manner from multiplicity of power sources. The disclosed system can comprising various functional modules such as a power source tracking module a data communication module, a data storage module, a carbon footprint calculation and statistical report generation module and a Graphical User Interface (GUI) module. The power source tracking module can be configured at each of the geographically distributed power consuming site that can continuously and in real time monitor source of electric power among various power sources used by the power consuming site. In an embodiment, the power source tracking module can comprise a microcontroller based Grid, DG, Battery power sensors and Battery voltage sensor.

The data communication module can be configured to communicate data collected by the power source tracking module from various power consuming sites to a server that houses other modules of the system. It can consist of a plurality of GPRS-GSM engines located at each of the power consuming sites and a power source status data receiving engine at the server.

The data storage module can be configured to store power source status data received from various geographically distributed power consuming sites and make it available to other modules of the system for further processing. The data storage module can also be housed in the server.

The carbon footprint calculation and statistical report generation module can be configured to prepare statistical reports pertaining to the geographically distributed power consuming sites in respect of power status, power outage, and carbon footprint of the power consuming site amongst others. The carbon footprint calculation and statistical report generation module can be located at the server and consist of a Centralized Processing System and a web application built on top of the Centralized Processing System. The reports can pertain to power status, power outage, and carbon footprint of the power consuming site amongst others. In an embodiment, the carbon footprint calculation and statistical report generation module, to provide a better comprehensibility of the information, can provide a geographical region wise display of the carbon footprint of the geographically distributed power consuming sites for a given period by means of a Thematic Map. The thematic map can be based on Geographic Information System (GIS) of Survey of India.

The graphical user interface module can be configured to provide various statistical reports and geographical region wise display of the carbon footprint of the geographically distributed power consuming sites to a user. The GUI module can be housed in a computing device such as a desk top, lap top, tablet, smart phone and other such devices that can be connected to the server using any of the Secure IP based communication network.

Other features of embodiments of the present disclosure will be apparent from accompanying drawings and from detailed description that follows.

### BRIEF DESCRIPTION OF THE DRAWINGS

In the Figures, similar components and/or features may have the same reference label. Further, various components of the same type may be distinguished by following the reference label with a second label that distinguishes among the similar components. If only the first reference label is used in the specification, the description is applicable to any one of the similar components having the same first reference label irrespective of the second reference label.

FIG. 1 illustrates an exemplary high level architecture for monitoring carbon footprint of geographically distributed power consuming sites that meet their power requirement in an uninterrupted manner from multiplicity of power sources in accordance with an embodiment of the present disclosure.

FIG. 2 illustrates an exemplary block diagram of the device for monitoring carbon footprint of geographically distributed power consuming sites in accordance with an embodiment of the present disclosure.

FIG. 3 illustrates an exemplary block diagram indicating various functional modules of system for monitoring carbon footprint of geographically distributed power consuming sites in accordance with an embodiment of the present disclosure.

FIG. 4A illustrates an exemplary web based application showing various statistical data pertaining to pertaining to mobile towersin accordance with an embodiment of the present disclosure.

FIG. 4B illustrates an exemplary web based application showing daily power status pertaining to mobile towersin accordance with an embodiment of the present disclosure.

FIG. 4C illustrates an exemplary extrapolated thematic map indicating carbon footprint of pertaining to mobile towers in various geographical regions (GIS administrative boundaries) in accordance with an embodiment of the present disclosure.

FIG. 4D illustrates an exemplary thematic map indicating mobile tower mapping within GIS administrative boundaries in accordance with an embodiment of the present disclosure.

FIG. 4E illustrates an exemplary different statistical reports namely: 1) report depicting carbon emission of each tower in the district with the average power outage and diesel consumption information, 2) chart depicting carbon emission of each telecom operator in the district, 3) chart depicting carbon emission in each village in the district with average power outage and diesel consumption information and 4) a district wise comparison report.

FIG. 5 illustrates an exemplary flow diagram of method for monitoring carbon footprint of geographically distributed power consuming sites that meet their power requirement in an uninterrupted manner from multiplicity of power sources in accordance with an embodiment of the present disclosure.

### DETAILED DESCRIPTION

Embodiments of the present disclosure include various steps, which will be described below. The steps may be performed by hardware components or may be embodied in machine-executable instructions, which may be used to cause a general-purpose or special-purpose processor programmed with the instructions to perform the steps. Alternatively, steps may be performed by a combination of hardware, software, firmware and/or by human operators.

Embodiments of the present disclosure may be provided as a computer program product, which may include a machine-readable storage medium tangibly embodying thereon instructions, which may be used to program a computer (or other electronic devices) to perform a process. The machine-readable medium may include, but is not limited to, fixed (hard) drives, magnetic tape, floppy diskettes, optical disks, compact disc read-only memories (CD-ROMs), and magneto-optical disks, semiconductor memories, such as ROMs, PROMs, random access memories (RAMs), programmable read-only memories (PROMs), erasable PROMs (EPROMs), electrically erasable PROMs (EEPROMs), flash memory, magnetic or optical cards, or other type of media/machine-readable medium suitable for storing electronic instructions (e.g., computer programming code, such as software or firmware).

Various methods described herein may be practiced by combining one or more machine-readable storage media containing the code according to the present disclosure with appropriate standard computer hardware to execute the code contained therein. An apparatus for practicing various embodiments of the present disclosure may involve one or more computers (or one or more processors within a single computer) and storage systems containing or having network access to computer program(s) coded in accordance with various methods described herein, and the method steps of the disclosure could be accomplished by modules, routines, subroutines, or subparts of a computer program product.

If the specification states a component or feature “may”, “can”, “could”, or “might” be included or have a characteristic, that particular component or feature is not required to be included or have the characteristic.

Although the present disclosure has been described with the purpose of enabling a GIS based centralized carbon footprint monitoring system (CFMS), it should be appreciated that the same has been done merely to illustrate the disclosure in an exemplary manner and any other purpose or function for which the explained structure or configuration can be used, is covered within the scope of the present disclosure.

Exemplary embodiments will now be described more fully hereinafter with reference to the accompanying drawings, in which exemplary embodiments are shown. This disclosure may, however, be embodied in many different forms and should not be construed as limited to the embodiments set forth herein. These embodiments are provided so that this disclosure will be thorough and complete and will fully convey the scope of the disclosure to those of ordinary skill in the art. Moreover, all statements herein reciting embodiments of the disclosure, as well as specific examples thereof, are intended to encompass both structural and functional equivalents thereof. Additionally, it is intended that such equivalents include both currently known equivalents as well as equivalents developed in the future (i.e., any elements developed that perform the same function, regardless of structure).

Thus, for example, it will be appreciated by those of ordinary skill in the art that the diagrams, schematics, illustrations, and the like represent conceptual views or processes illustrating systems and methods embodying this disclosure. The functions of the various elements shown in the figures may be provided through the use of dedicated hardware as well as hardware capable of executing associated software. Their function may be carried out through the operation of program logic, through dedicated logic, through the interaction of program control and dedicated logic, or even manually, the particular technique being selectable by the entity implementing this disclosure. Those of ordinary skill in the art further understand that the exemplary hardware, software, processes, methods, and/or operating systems described herein are for illustrative purposes and, thus, are not intended to be limited to any particular named.

Embodiments of the present disclosure relate to carbon footprint monitoring. In particular it pertains to a geographic information system (GIS) based centralized carbon footprint monitoring system (CFMS) that can monitor carbon footprint related to geographically distribute power consuming sites that meet their power requirement in an uninterrupted manner from multiplicity of power sources. Such geographically distributed power consuming sites could be for example but not limited to Base Trans-receiver Stations pertaining to communication networks.

In an embodiment, the present disclosure provides for carbon footprint monitoring based on real time monitoring of source of electric power among various power sources such as but not limited to grid or Diesel Generator or battery, to a particular power consuming site. Power source status collected at various power consuming sites can be periodically or instantly (on detection of any change in power status) communicated to a Centralized Processing System that can store the data and generate statistical reports such as power status, power outage, and carbon footprint of these sites.

In an embodiment, the statistical reports can be prepared by a web application built on top of the Centralized Processing System which can additionally incorporate, to provide a better comprehensibility of the information, a geographical region wise display of the carbon footprint of the power consuming sites for a given period by means of a Thematic Map.

It is to be appreciated that though various embodiments have been explained with reference to mobile BTS towers, the method, system and device of the present disclosure can equally well be applied for monitoring carbon footprint of any other geographically distribute power consuming applications either individually or a combination that meet their power requirement in an uninterrupted manner from multiplicity of power sources.

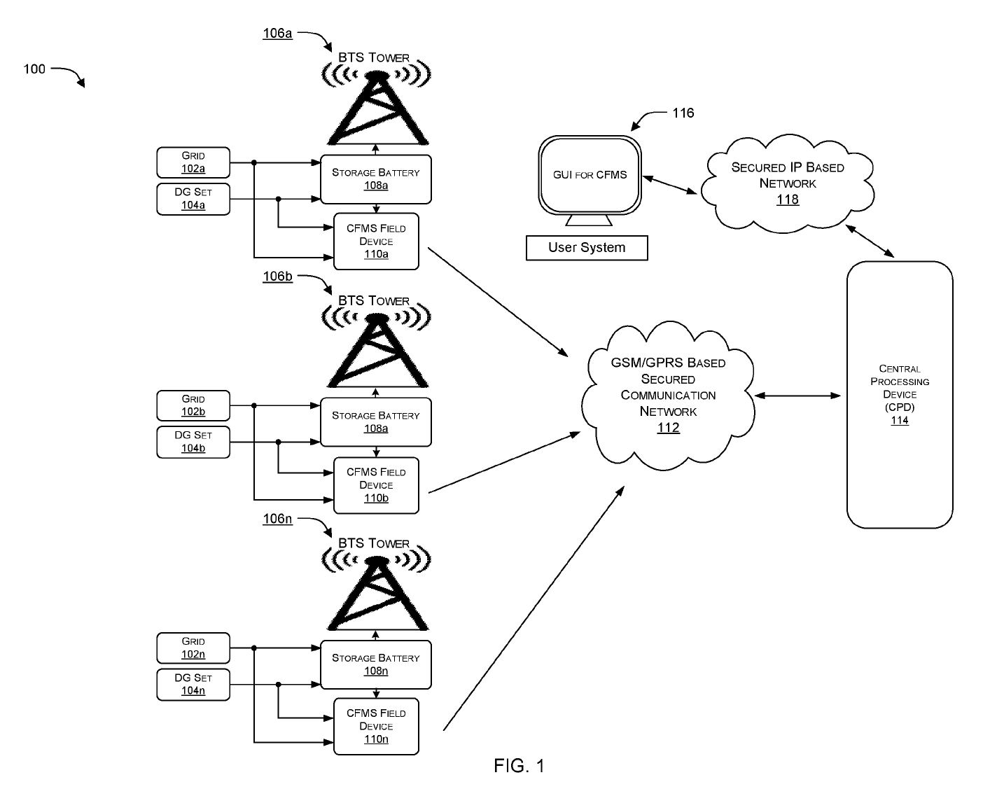

Referring now to FIG. 1 wherein an exemplary high level architecture 100 for monitoring carbon footprint of geographically distributed power consuming sites that meet their power requirement in an uninterrupted manner from multiplicity of power sources has been disclosed. As shown plurality of exemplary geographically distributed power consuming sites can be BTS towers 106 that meet their uninterrupted power requirement from the battery bank 110 which in turn draws power from grid 102 or in the event of failure of grid supply from a DG set 104. Each of the power sources i.e. the grid 102 and the DG set 104 has its own carbon footprint. Therefore, carbon footprint pertaining to operation of a particular BTS tower such as 106a for a particular period shall depend on durations for which its battery bank 108a was being charged by grid 102a and the DG set 104a.

It is to be understood that though the exemplary architecture for monitoring carbon footprint of geographically distributed power consuming sites that meet their power requirement in an uninterrupted manner from multiplicity of power sources shows only two power sources, namely the grid 102 and the DG set 104, there can be any number of power sources such as solar, biomass, wind, natural gas based etc. to name a few, each having different carbon footprint, and the present method, system and device can cater to any number of such sources without any limitation. Likewise geographically distributed power consuming sites can be any other utility other than BTS towers such as hospitals, data centers, cinemas, metro rails control centers and the likes that need uninterrupted power supply. Any one of such utilities or a combination thereof can be benefitted by the present disclosure for monitoring the carbon footprint.

As shown in FIG. 1, there can be a CFMS Field Device 110 (also referred to as field device 110 and the terms used interchangeably) positioned at each of the distributed power consuming sites 106 and configured to continuously and in real time sense status of power sources such as the Grid 102 and the DG 104. It can additionally sense the voltage of the Battery 108. In an aspect, sensing the battery voltage can enable to determine operational status of the power consuming site 106. In an embodiment, the field device 110 can comprise a microcontroller based Grid, DG, Battery power sensors and Battery voltage sensor.

In an embodiment, the Field Devices 110 can, periodically or instantly (on detection of any change in power status), communicate the sensed status of power sources to a Centralized Processing Device (CPD) 114 through a GSM/GPRS based secured communication network 112. For this purpose, each of the Field Devices 110 can incorporate GPRS-GSM engines. The CPD 114 can be a centralized server configured to receive and store the data from plurality of Field Devices 110 and can incorporate a web based solution (CFMS solution) to process the stored data and provide live statistical reports pertaining to power status, power outage, and carbon footprint of the power consuming sites 108. The CPD 114, to provide a better comprehensibility, can further incorporate means of providing geographical region wise information pertaining to the carbon footprint of the geographically distributed power consuming sites for a given period on a Thematic Map. The thematic map can be based on Geographic Information System (GIS) of Survey of India.

In an embodiment, a user can access the live statistical reports and information pertaining to power status, power outage, and carbon footprint of the power consuming sites 108 through thematic maps through a computing device 116 such as a desk top, lap top, ipad and like such devices. User's device 116 can access these reports and information from the CPD 114 through an IP based secured communication network 118.

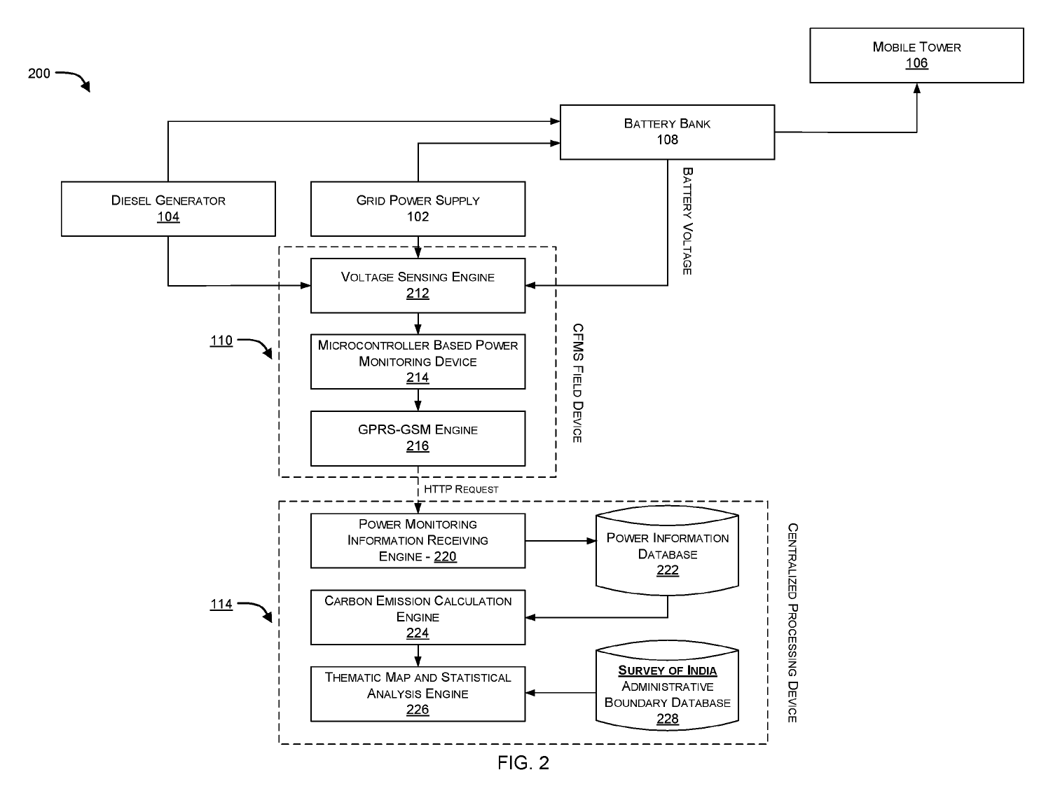

FIG. 2 illustrates an exemplary block diagram 200 of the device for monitoring carbon footprint of geographically distributed power consuming sites in accordance with an embodiment of the present disclosure. As stated earlier and shown in FIG. 2, the device can comprise of a plurality of CFMS field devices 110 located at each of the power consuming sites and a CPD 114. The CPD 114 can be located at a centralized server. As further shown in the FIG. 2, a mobile or BTS tower 106 as an exemplary power consuming site, receives power from the attached battery bank 108 which in turn gets power for charging from Grid 102 and in the event of failure of grid supply from the DG set 104.

In an embodiment, each of the field device 110 can comprise a voltage sensing engine 212, a microcontroller based power monitoring device 214 and a GPRS-GSM engine 216. The a microcontroller based power monitoring device 214 can, through the voltage sensing engine 212, continuously and in real time monitor voltage of the grid supply 102, DG supply 104 and the battery voltage. In an embodiment, sensing of voltage of the grid supply 102 and the DG supply 104 can determine if the power requirement for charging the battery 108 is being met from grid 102 or the DG set 102.

In an embodiment, the microcontroller based power monitoring device 214, through the voltage sensing engine 212, can additionally sense the battery voltage. In an aspect, sensing the battery voltage can enable to determine operational status of the power consuming site 106.

In an embodiment, the microcontroller based power monitoring device 214, through the GPRS-GSM engine 216, can communicate the generated data relating to status of the power sources to the CPD 114. The communication can take place periodically. However, whenever a change in status of a power source takes place the status can be communicated instantly to maximize the data accuracy.

In an embodiment, the CPD 114 can comprise a power monitoring information receiving engine 220, a carbon emission calculation engine 224, thematic map and statistical analysis engine 226, a power information database 222 and an administrative boundary database 228. The power monitoring information receiving engine 220 can be configured to receive the power status monitoring data communicated by various field units 110 over a GSM/GPRS based secure communication network 112 (refer FIG. 1) and store the same in the power information database 222 for retrieval by the carbon emission calculation engine 224. The carbon emission calculation engine 224 can be configured to process, calculate and analyse the data before presenting it to a user, based on the query raised by him/her through an integrated web based application.

In an embodiment, the carbon emission calculation engine 224 can comprise a web based application (CFMS solution) configured to provide live power status of the geographically distributed power consuming sites 106 connected to CPD 114. The web based application can be configured to provide comprehensive statistical reports based on the power sources data. The web based application can access power status data and provide live power status, daily power status summary, and daily power outage and emitted carbon of a particular power consuming site or a combination of these sites in a tabulated manner.

In an embodiment, the carbon emission calculation engine 224 can calculate carbon footprint pertaining to operation of a power consuming site using following formula:

CE=P*CFg*Tg+DG Capacity*CFd*Td

Where,
CE: Calculated Carbon footprint (in kg).
P: The grid power consumed. For the exemplary power consuming site BTS tower it can be3 KW.
CFg: The grid carbon emission factor i.e. amount of CO₂ emitted for each unit of grid power used. Its value can be taken as 0.84 Kg/unit.
Tg: The time for which the grid power is available. It can be derived by the carbon emission calculation engine 224 from the power status data stored in the power information database 222.
DG Capacity: is the capacity of the DG set 104 being used. For the exemplary power consuming site BTS its value can be taken to be 15-20 KVA.
CFd: The carbon emission factor of the DG Set. That is, the amount of carbon emitted for every single litre of diesel consumed. Its value is taken to be 2.68 Kg/litre and the diesel consumption rate can be assumed as 4 litre/hour.
Td: The time for which the grid power is unavailable and DG Set. It can be derived by the carbon emission calculation engine 224 from the power status data stored in the power information database 222.

In an embodiment, based on calculated carbon footprint data for individual power consuming sites, region wise thematic map of carbon footprint can be generated. Thematic map can shows carbon footprint of the power consuming sites located within a geographical area in different colours for a desired time period wherein each colour can signify a carbon footprint range. Further the geographical area can be a administrative unit such as a village or a tehsil or district for which Survey of India (SOI) village boundary data can be used. In an embodiment, the administrative unit boundary data can be stored in the administrative boundary database 228.

In an embodiment, a user can access the required information/statistical report/thematic map using a computing device through a web application built on top of the CPD 114 using a GSM/GPRS based secured communication network 112 (FIG. 1). User can also ascertain operational status of a particular power consuming site (mobile tower in the exemplary embodiment) based on sensed battery voltage by the field device 110 wherein a battery voltage value under a threshold level can indicate that the battery is in deep discharge and the Mobile Tower is not transmitting signal.

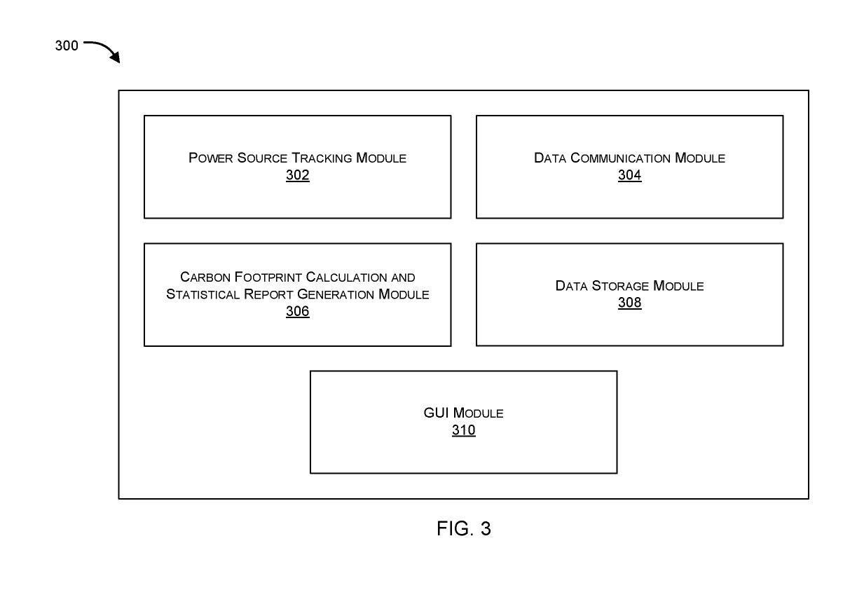

FIG. 3 illustrates an exemplary block diagram indicating functional modules of the centralized GIS based CFM system 300 in accordance with an embodiment of the present disclosure. The disclosed system can comprise various functional modules such as a power source tracking module 302, a data communication module 304, a data storage module 308, a carbon footprint calculation and statistical report generation module 306 and a Graphical User Interface (GUI) module 310. The power source tracking module 302 can be configured at each of the geographically distributed power consuming sites that can continuously and in real time monitor source of electric power among various power sources used by the power consuming site. In an embodiment, the power source tracking module 302 can comprise a microcontroller based Grid, DG, Battery power sensors and Battery voltage sensor.

The data communication module 304 can be configured to communicate data collected by the power source tracking module from various power consuming sites to a server that houses other modules of the system. It can consist of a plurality of GPRS-GSM engines located at each of the power consuming sites and a power source status data receiving engine at the server.

The data storage module 308 can be configured to store power source status data received from various geographically distributed power consuming sites and make it available to other modules of the system for further processing. The data storage module can also be housed in the server. It can additionally store administrative boundaries data base of Survey of India which can be used for preparing thematic maps to present carbon footprint of the power consuming sites located in different geographical resigns as defined by administrative boundaries.

The carbon footprint calculation and statistical report generation module 306 can be configured to prepare statistical reports pertaining to the geographically distributed power consuming sites in respect of power status, power outage, and carbon footprint of the power consuming site amongst others. The carbon footprint calculation and statistical report generation module can be located at the server and consist of a Centralized Processing System and a web application built on top of the Centralized Processing System. The reports can pertain to power status, power outage, and carbon footprint of the power consuming site amongst others.

In an embodiment, the carbon footprint calculation and statistical report generation module 306 can calculate carbon footprint pertaining to operation of a power consuming site using following formula:

CE=P*CFg*Tg+DG Capacity*CFd*Td

Where,
CE: Calculated Carbon footprint (in kg).
P: The grid power consumed. For the exemplary power consuming site BTS tower it can be 3 KW.
CFg: The grid carbon emission factor i.e. amount of CO₂ emitted for each unit of grid power used. Its value can be taken as 0.84 Kg/unit.
Tg: The time for which the grid power is available. It can be derived by the carbon footprint calculation and statistical report generation module 306 from the power status data stored in the data storage module 308.
DG Capacity: is the capacity of the DG set 104 being used. For the exemplary power consuming site BTS its value can be taken to be 15-20 KVA.
CFd: The carbon emission factor of the DG Set. That is, the amount of carbon emitted for every single litre of diesel consumed. Its value is taken to be 2.68 Kg/litre and the diesel consumption rate can be assumed as 4 litre/hour.
Td: The time for which the grid power is unavailable and DG Set. It can be derived by the carbon footprint calculation and statistical report generation module 306 from the power status data stored in the data storage module 308.

In an embodiment, the carbon footprint calculation and statistical report generation module 306, to provide a better comprehensibility of the information, can provide a geographical region wise display of the carbon footprint of the geographically distributed power consuming sites for a given period by means of Thematic Maps. The thematic maps can be based on Geographic Information System (GIS) of Survey of India.

The graphical user interface module 310 can be configured to provide various statistical reports and geographical region wise display of the carbon footprint of the geographically distributed power consuming sites to a user. The GUI module 310 can be housed in a computing device such as a desk top, lap top, tablet, smart phone and other such devices that can be connected to the server using any of the GPRS/GSM base communication network.

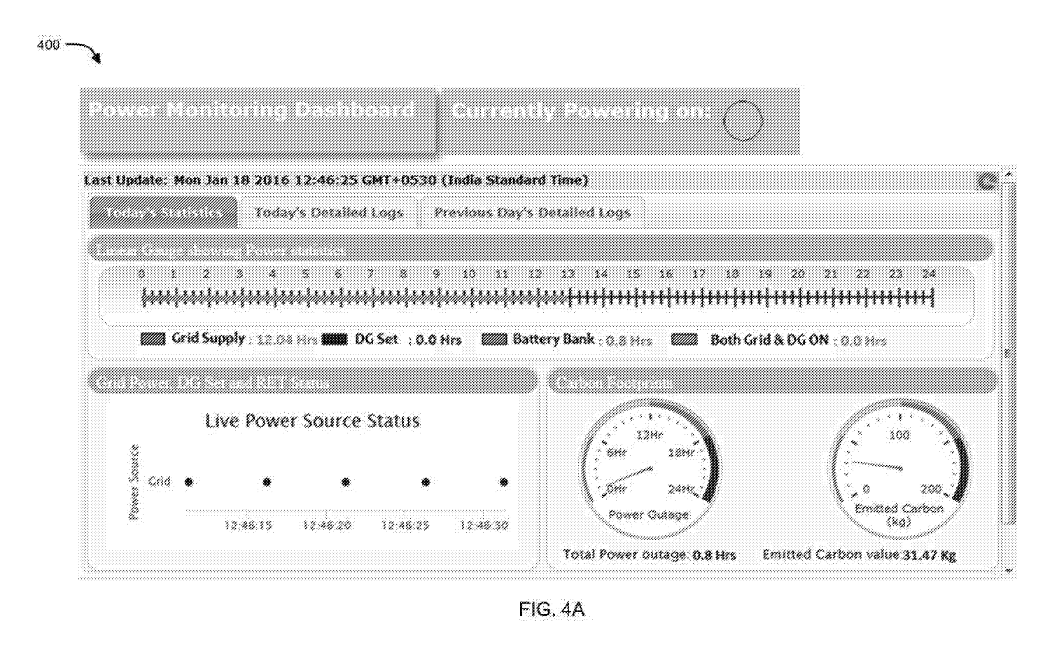

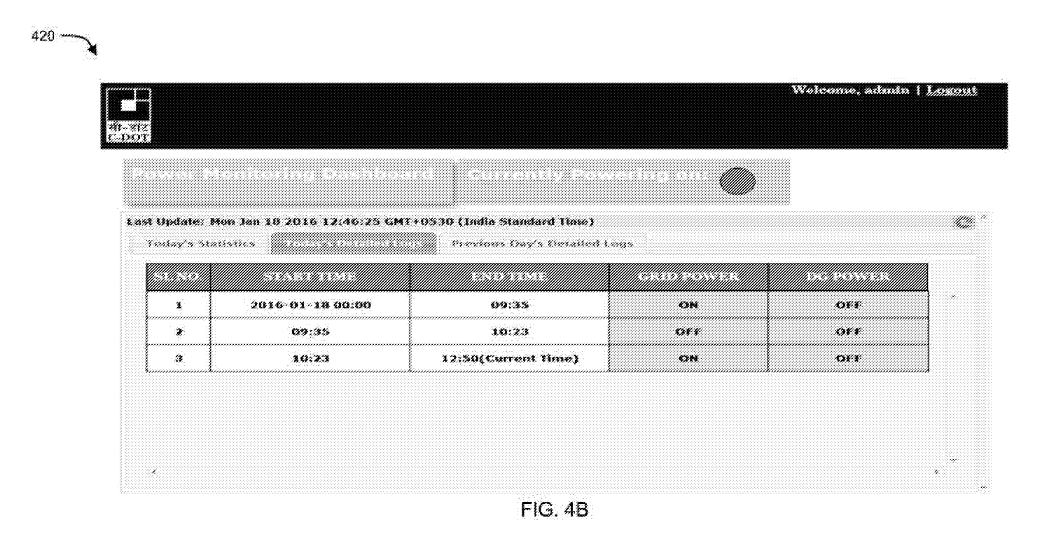

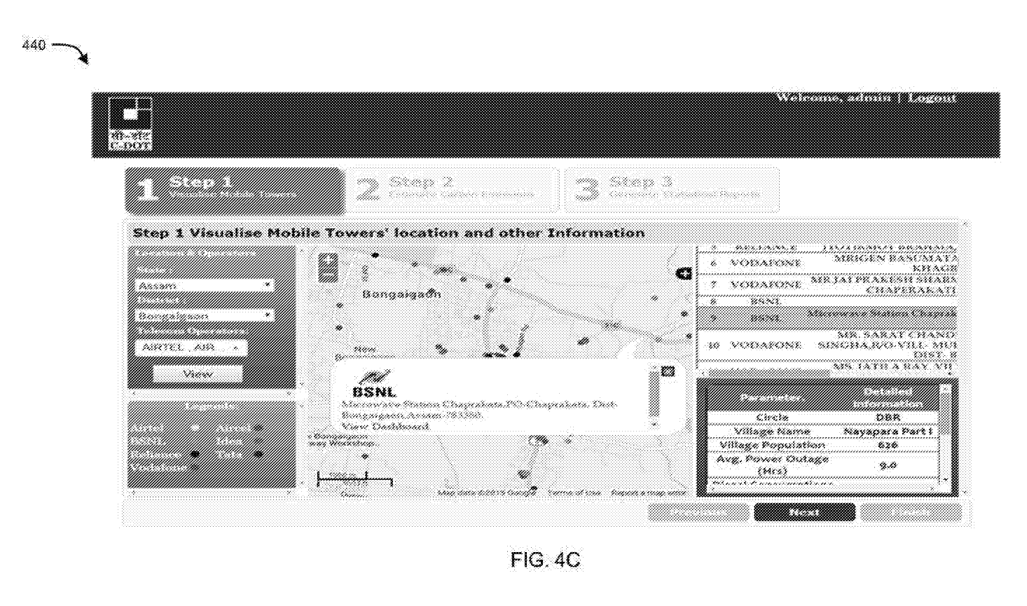

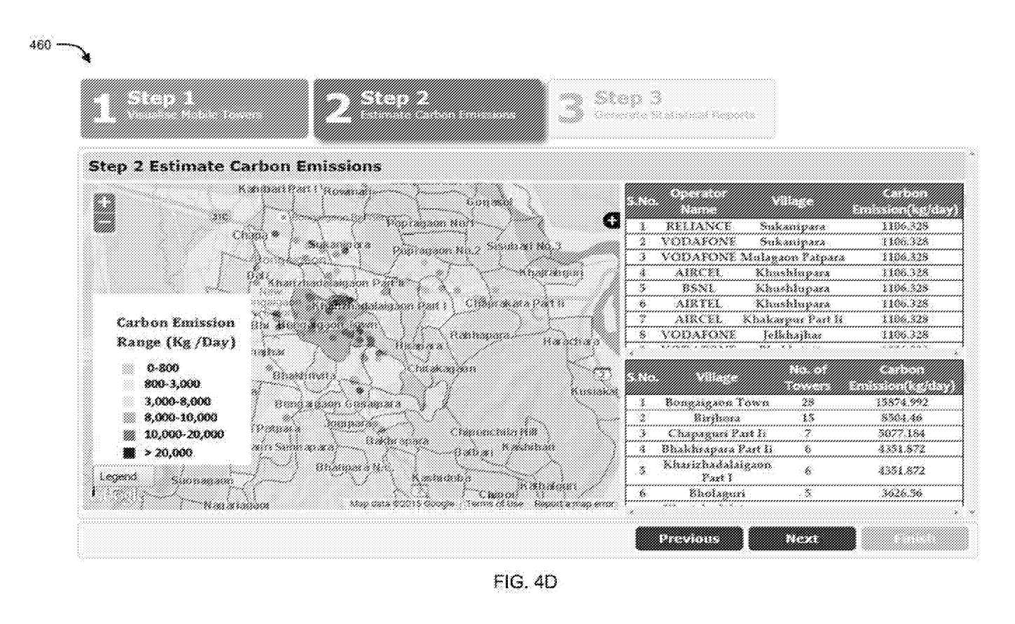

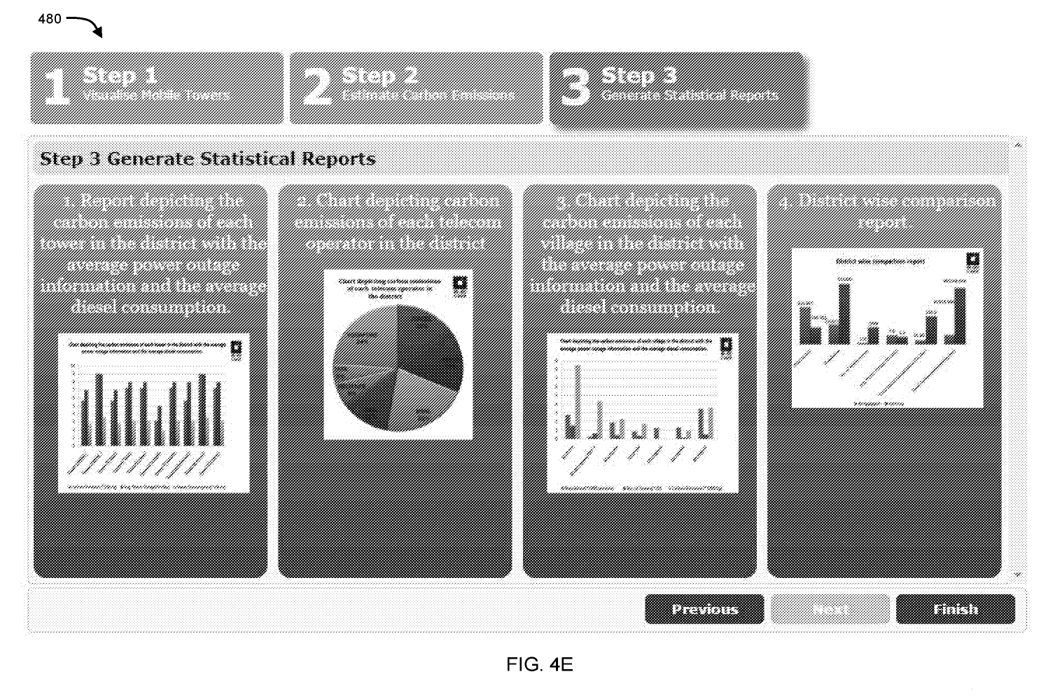

FIGS. 4A to 4E illustrate some exemplary screenshots of the graphical interface through web based application and displaying statistical data and carbon footprint pertaining to distributed power consuming sites wherein FIG. 1 illustrates starting screenshot 400 pertaining to a power consuming site. When a user clicks on the “Power Monitoring Dashboard” tab of the screen, the window can show last update information that the web based application has taken from the server to calculate and represent the data. The time of the last updated information can be displayed for example as Mon Jan. 18 2016 12:46:25 GMT+0530 (Indian Standard Time) as shown in the screen shot 400, and it can be refreshed using the refresh icon provided on the screen. Further the sub tabs are provided to select options of—Today's Statistics, Today's detailed Logs, Previous Day's Detailed Log. On clicking on the sub tab “Today's Statistics”, a24 hour Linear Gauge Showing Power Statistics can appear which can show status of power sources such as grid or DG or battery bank in different colours along with duration such as 12.04 and 0.8 Hrs indicated against Grid supply and Battery bank respectively in the exemplary screenshot 400.

Under another heading “Carbon Footprints” two meters have been shown for power outage and emitted carbon along with quantitative values for total power outage and emitted carbon values shown below. For example: Power Outage meter scale shows approx. 1 hour duration on scale of 0-24 hours, whereas Emitted carbon meter scale shows approx. 30 kilograms of carbon emitted.

FIG. 4B illustrates an exemplary screen shot 420 that a user may see on clicking on the second tab “Today's Detailed Logs”. As shown in screenshot 420, each incidence of changeover of power from one source to other gets displayed in chronological order along with time of occurrence and status of the power sources.

FIG. 4C illustrates an exemplary screenshot 440 of thematic map indicating carbon footprint of geographically distributed power consuming sites in different regions. As shown in screenshot 440, process of visualizing thematic map can be a three step process and the screenshot provides three tabs corresponding to the three steps, wherein at step 1 clicking tab “Step 1—Visualize Mobile Towers” can result in display of all the power consuming sites working in a particular area as defined by the user. User can define the geographical region by selecting State and district from the menu on left side of the screen. The screen can thereafter display all the towers of different mobile operators working in the desired area. The display can also incorporate details pertaining to each of these towers such as name of the operator and details of the selected region such as population, average power outage etc.

FIG. 4D illustrates an exemplary screenshot as seen on clicking on next tab “Step 2—Estimate Carbon Emission” can result in display of the region wise carbon footprint in addition to location of towers. The map can indicate the level of carbon footprint in different regions by different colours. On the right side of pane two tables can appear wherein the first Table can tabulate names of the operators of different towers located in the selected region along with value of carbon footprint of the tower, and the second table can tabulate region wise details of the power and their total carbon footprint.

FIG. 4E illustrates an exemplary screenshot as seen on clicking on next tab “Step 3—Generate Statistical Reports”. As can be seen this action by a user can display four different reports namely: 1) report depicting carbon emission of each tower in the district with the average power outage and diesel consumption information, 2) chart depicting carbon emission of each telecom operator in the district, 3) chart depicting carbon emission in each village in the district with average power outage and diesel consumption information and 4) a district wise comparison report.

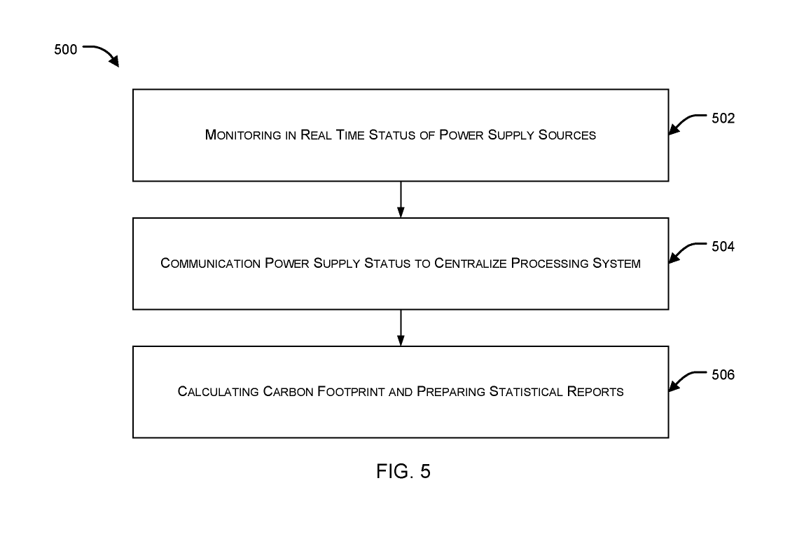

FIG. 5 illustrates an exemplary method flow diagram 500 for GIS based CFMS in accordance with an embodiment of the present disclosure. As shown in the flow diagram 500, the method for carbon footprint monitoring can at step 502 monitor in real time different sources of electric power supplying to various geographically distributed power consuming sites. The power supply sources can be but not limited to grid or Diesel Generator or battery and the status can be monitored by monitoring voltage using a microcontroller based tracking device configured with each of the geographically distributed power consuming sites. At step 504, the method 500 provides for periodic communication of the captured data from the geographically distributed power consuming sites to a Centralized Processing System that is configured to store the data and generate statistical reports relating to carbon footprint of the geographically distributed power consuming sites. The means for communication between the geographically distributed power consuming sites and the Centralized Processing System can be a GSM/GPRS based communication network and the Centralized Processing System can be located in a server. At step 506 the disclosed method provides for preparation of various statistical reports pertaining to the geographically distributed power consuming sites wherein the statistical reports are prepared by a web application built on top of the Centralized Processing System. The reports can pertain to power status, power outage, and carbon footprint of the power consuming site amongst others. In an embodiment, to provide a better comprehensibility of the information, the disclosed method provides for geographical region wise display of the carbon footprint of the geographically distributed power consuming sites for a given period by means of a Thematic Map. The thematic map can be based on Geographic Information System (GIS) of Survey of India.

It is to be appreciated that though various embodiments have been explained with reference to mobile BTS towers that use grid and DG power as only sources of power, the embodiments of the present disclosure can equally well be applied for monitoring carbon footprint of any other geographically distribute power consuming applications either individually or a combination that meet their power requirement in an uninterrupted manner from multiplicity of power sources such as grid, DG, solar power, wind power to name a few.

It should be apparent to those skilled in the art that many more modifications besides those already described are possible without departing from the inventive concepts herein. The inventive subject matter, therefore, is not to be restricted except in the spirit of the appended claims. Moreover, in interpreting both the specification and the claims, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced. Where the specification claims refers to at least one of something selected from the group consisting of A, B, C . . . and N, the text should be interpreted as requiring only one element from the group, not A plus N, or B plus N, etc. The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the appended claims.

While embodiments of the present disclosure have been illustrated and described, it will be clear that the disclosure is not limited to these embodiments only. Numerous modifications, changes, variations, substitutions, and equivalents will be apparent to those skilled in the art, without departing from the spirit and scope of the disclosure, as described in the claims.

### Advantages of the Invention

The present disclosure provides a system for carbon footprint monitoring for distributed power consuming sites that draw power from multiple sources.

The present disclosure provides a system that can accurately determine the carbon footprint based on real time ground level data collection.

The present disclosure provides a system for determining carbon footprint of the distributed power generating sites located in different geographic regions.

The present disclosure provides a centralized system for data collection from the distributed power generating sites through secured communication network.

The present disclosure provides system and method to effectively display or represent the carbon footprint.

We claim:

1. A system for monitoring Carbon Footprint of geographically distributed power consuming sites that meet their power requirement from multiplicity of power sources, the system comprising:
a power source tracking module located at each of the geographically distributed power consuming sites and configured to continuously and in real time monitor source of electric power among various power sources used by the power consuming sites;
a data communication module, configured to communicate power source data collected by the power source tracking module from various power consuming sites to a server;
a data storage module located at the server and configured to store power source status data received from various geographically distributed power consuming sites; and
a carbon footprint calculation and statistical report generation module located at the server and configured to prepare statistical reports pertaining to the geographically distributed power consuming sites and calculate carbon footprint.

2. The system of claim 1, wherein the system further comprises a web application built on top of the Centralized Processing System configured to provide to a user the statistical reports and carbon footprint of the geographically distributed power consuming sites through a computing device of the user.

3. The system of claim 2, wherein the statistical reports and the carbon footprint of the geographically distributed power consuming sites is provided through thematic map sand wherein the thematic maps are based on Geographic Information System (GIS) of Survey of India.

4. The system of claim 1, wherein the geographically distributed power consuming sites draw power from the multiplicity of power sources in an uninterrupted manner and status of operation of the power consuming site is determined based on sensed voltage of battery bank supplying power in an uninterrupted manner and the operating status of the power consuming sites is included in the statistical reports.

5. The system of claim 1, wherein the data communication module communicates the power source data periodically or immediately on any change in power status; and communication of the power source data is through a GSM/GPRS based secure communication network.

6. The system of claim 1, wherein the geographically distributed power consuming sites are BTS towers and the multiplicity of power sources are grid, Diesel Generator and battery bank.

7. A Carbon Footprint Monitoring System (CFMS) device for monitoring Carbon Footprint of geographically distributed power consuming sites that meet their power requirement from multiplicity of power sources, the device comprising:
a CFMSField Device located at each of the geographically distributed power consuming sites and consisting of a microcontroller configured to sense status of the multiplicity of power sources and communicate the sensed data to a server;
a Centralized Processing Device (CPD) located in the server and configured to receive and store the data from plurality of CFMS Field Devices and further configured to prepare statistical reports pertaining to the geographically distributed power consuming sites and calculate carbon footprint.

8. The device of claim 7, wherein the device further incorporates a web application built on top of the Centralized Processing System configured to provide to a user the statistical reports and carbon footprint of the geographically distributed power consuming sites through a computing device of the user; and wherein the statistical reports and the carbon footprint of the geographically distributed power consuming sites is provided through thematic maps and wherein the thematic maps are based on Geographic Information System (GIS) of Survey of India.

9. The device of claim 7, wherein the geographically distributed power consuming sites draw power from the multiplicity of power sources in an uninterrupted manner and status of operation of the power consuming site is determined based on sensed voltage of battery bank supplying power in an uninterrupted manner and the operating status of the power consuming sites is included in the statistical reports.

10. The device of claim 7, wherein the sensed data is communicated to the server periodically or immediately on any change in power status; and communication of the sensed data is through a GSM/GPRS based secure communication network.
